(19) United States
(12) Patent Application Publication
(10) Pub. No.: US 2005/0182673 A1
(43) Pub. Date: Aug. 18, 2005

(54) Method for automatic pattern recognition and regulation of economic processes pattern recognition system and autopilot for economic processes taking into account the productive value of customer relations

(76) Inventors: Sieghard Marzian, Krefeld (DE); Wolfhart Smidt, Garbsen (DE); John Gaudet, Gulfport, FL (US); Kai Wille, Krefeld (DE)

Correspondence Address: LERNER AND GREENBERG, PA, P O BOX 2480, HOLLYWOOD, FL, 33022-2480, US

(21) Appl. No.: 10/488,148

(22) PCT Filed: Aug. 30, 2002
(86) PCT No.: PCT/EP02/09709

(30) Foreign Application Priority Data
Aug. 31, 2001 (DE) 101 42 412.4
Dec. 20, 2001 (DE) 101 62 743.2

(51) Int. Cl. G06F 17/60

(52) U.S. Cl. 705/10

(57) ABSTRACT

The invention relates to a method for automatic pattern recognition in economic processes, taking into account a productive value for customer relations, using a digital processing system (1), whereby a number of process-relevant input parameters and/or process-relevant control parameters are at least partially automatically recorded with suitable data recording means (12), such as physical, chemical, biological or digital measuring heads (6 to 9) and at least one characteristic parameter is at least partially automatically determined, based on the input parameters and/or control parameters. The invention also relates to a method for automatic regulation, using the characteristic parameters as determined, which carries out an electronic selection of the control parameters, corresponding to the result of a comparison, from comparing the characteristic parameter with at least one reference value, which for its part has an influence on the economic process, such that an automatic regulated loop is achieved. The invention further relates to a pattern recognition system (10) and autopilot system (11) corresponding to the above method. The invention is advantageously characterised in that complex relationships, such as are usual in economic processes, can be at least partially automatically recorded and processed, such that at least a part of the economic process can be regulated whilst taking into account the productive value of customer relations. The invention permits an objective evaluation of process-relevant input parameters, without the subjective interpretations of an individual influencing the results of the pattern recognition or the automatic regulation.

The invention concerns respectively a method for pattern recognition in economic processes and a method for regulating economic processes, in particular in purchasing or distribution processes, taking into account a customer equity, the customer equity being represented by a matrix, the matrix comprising as input data process-characterizing process parameters, as well as a pattern recognition system or respectively an autopilot system for economic processes.

It is known that in particular the distribution service of a company must direct itself to customer value and costs must be determined based on the customer, since a successful development and a growth of the business can only be achieved with customers. This fact is as valid for consumer goods manufacturers and for providers of investment products as it is in general for providers of goods and services. In economic processes, in particular in purchasing or distribution processes, the concept of customer orientation plays a decisive role. In this connection the problem of quantifying customer orientation arises. In particular, it is often difficult to decide whether in a given situation the customer's wishes should be more strenuously catered to than before or whether the current activities or concessions with respect to the customer are sufficient.

A quantification of customer orientation cannot be directly correlated with the turnover generated by the customer, since an achieved turnover value reveals nothing about the profitability of the customer. Although customers, in particular large customers, do indeed want the best possible service, admittedly in two thirds of cases the price of a product tips the balance, as surveys in the investment product industry have shown.

Up to now customers have de facto only been evaluated according to their turnover. Depending on turnover level, customers were divided by sales and marketing for example into A, B, C and D customers; visit frequency of the sales staff and other services were determined according to this classification. Since turnover reveals little about the profitability of a customer, in many branches, even with the largest turnover customers, losses have to be accepted, because these customers make disproportionate demands on services, which are neither charged nor accounted for. Turnover is unsuitable as a sole input parameter for quantifying customer orientation.

Since it is difficult to establish the value of customer relations, it has thus far not been possible to anticipate future developments in customer relations, e.g. a customer potential. Customer life cycles are not researched and most businesses therefore have in reality no customers, or thus far serve a clientele which, in respect of its profitability, is made up of an amorphous mass of consumers. Thus a “future-oriented reporting” and a “necessary data and information supply” are absent.

The intransparency, in particular of distribution processes and the thereto contingent planning deficit or respectively the lacking rational business maxims are all the more meaningful when distribution has a key role in the success of the business, since distribution forms the most important interface with the customer.

One difficulty in quantifying customer relations is that the correspondence of important concepts, such as, e.g., proximity to customer, customer satisfaction or customer retention, is not presently researched. In particular, the complexity of the problem and the multi-layered nature of customer relations cause formidable difficulties in the assignment of simple business maxims. Furthermore the evaluation of a complex connection such as an economic process or customer relation by a person or a group of people is often only unsatisfactorily possible, since the subjectivity of the individual observer often obstructs an objective approach to evaluation. Taking into account the multi-layered nature of the connections under consideration, objective criteria are necessary for evaluating customer relations.

The significance of a quantification of customer relations lies for example in that it can reveal who should be considered a customer (customer focus), how intensively customers should be served (allocation, i.e. assignment of business resources), or when customer-related measures should be started (timing of measures).

A measure of the customer relations is defined by the so-called customer equity. The customer equity has substantially three components: the pre-plannable customer result in a manageable forecast period (ca. three to five years, depending on the chosen market strategy); the actual customer result after the forecast period (residual value); the capital costs of the customer relations. To determine the customer success (ideally on a cash-flow basis) specific value drivers (success factors) are determined. To adapt to the respective economic process the respective parameters can be selected based on their relevance.

In order for the customer equity to be meaningful, a substantial amount of information describing the customer-provider system must first be collected and then consolidated, evaluated and converted into corresponding measures. Thus the main focus of a customer equity lies, in contrast to conventional economic characterization systems, not only in the observation of the past, but also in information suitable for broadly describing future developments. The significance of the customer equity lies in its orientation towards the future, which enables forecasting of future developments of the economic process.

The following difficulties arise in investigating a customer equity.

Firstly, an area of conflict exists between parameters which are directly attributable to the client (for example costs) and information which is, rather, indirectly assigned to an individual customer (for example the general market evolution or the value of a reference for other customers).

The second difficulty arises because hard factors such as e.g. turnover figures, stock-exchange price or salaries must be combined with soft factors such as e.g. the value of a reference, the value of a brand or the value of a knowledge transfer, in order to arrive at an integrated evaluation system. In this way quantitative, for example money-value-oriented figures can be evaluated integrated with qualitative information. The significance of soft factors is, however, just as important as the significance of hard factors in the determination of the customer equity. For example, many businesses earn comparably little from business with automobile manufacturers, since the conditions are too narrowly drawn up and the hard purchase and contractual conditions cannot generate any notable profit margins. The reason for which the businesses collaborate with the manufacturers is that know-how and competence increase from collaboration with manufacturers, which the businesses can use in other customer segments. Logistic service providers use, for example, the trendsetting automobile industry in order to be able to sell innovative logistic concepts in engineering. In this way the reference list of the automobile industry serves as visiting card.

The third difficulty lies in the extrapolation from past facts and figures and the prediction of future development. An extrapolation into the future is constantly beset with insecurity.

It is essential from the perspective of the customer equity to determine a differentiated status of the present and future situation. Potential, risk, degree of consumption, revenues and client-related costs, expenditure and investments must therefore be systematically determined and then respectively processed or made available. Furthermore, opportunities and risks, which a customer presents for the business, must be carefully researched and regularly checked. With this information, which must usually be maintained in a specially-conceived database, e.g. known under the terms MMS (Market Management System) or VIS (Distribution Information System), the dynamics of these parameters should be described. Market developments, trends and modification of external parameters must be taken into account.

In addition to the substantially textual information from a customer database, cost accounting serves as second important information source for quantification of customer relations. All services provided for the customer should ideally be calculated in a cost accounting.

Costs are combined from costs of market creation and market maintenance, costs of obtaining contracts, costs of fulfilling contracts, etc. The methodology of projection is well known from other business areas and consists in an encompassing process description, in the exploration in particular of the questioning of the customer regarding the different phases of the customer dialog up to the transaction and the sales contact. By attribution of the costs to the individual activities or process levels respectively, a correspondence between resources, processes and costs can be established. The cost accounting model encompasses likewise a time reference and an activity reference as basic requirement, in order to be able to control distribution timing, resources and/or allocation according to customer value.

As a further source of information for determining a customer equity the present customer satisfaction and the future requirements and needs profile of the customer must be determined. Until now satisfaction and needs analyses were mostly carried out in the form of structured interviews and questionnaires, which were then evaluated. The quality evaluation results from results—which are internally measured and externally evaluated by the customer—of all performances of the processes, products and people involved. In this respect are counted among other things employee competence and conduct, technical support, technical documentation, price-service performance, relationship to the competition and other factors. Methods and approaches to such quality investigations are long known.

Procedures improve in the course of collaboration of a customer with a provider. Efficiency increases if both sides know what and how something should be done. Common cost reduction programs lead to cost savings, which would not be realized with new customers. If the customer is satisfied with his supplier after years of collaboration, he will increasingly further recommend him. A loyal customer is mostly not so easily influenced by competitors' low prices, so that the price level for regular customers is generally higher than for fickle customers.

By reason of the multi-layer nature of the described problem it has until now not been possible to collect the considerable amount of information and to consolidate it and further process it to determine a customer equity. The complexity arising from the number of input parameters and the hard to quantify soft parameters made impossible a calculation of the customer equity using ordinary means prevalent in economics.

In particular, the subjective interpretation of a person produced an obstacle to determining a customer equity since, in view of the complexity of the problem, the human need to reduce complex relationships to simple models often leads to evaluations based on flawed preconceptions.

The problem described herein thus arises only superficially exclusively from the commercial domain. Rather, it presents, by reason of its internal structure, an essentially technical problem, which comprises the processing of a mass of unstructured data according to objective criteria. This technical problem requires a technical solution.

It is therefore an object of the present invention to create a process with which a customer equity can be determined, or respectively to provide a process according to which an economic process can be regulated, taking into account the customer equity, wherein the processes should work at least partially independently from the subjective evaluations of one or more people. A pattern recognition system for economic processes should furthermore be provided, with which the customer equity can be determined and predictions permitted for the future development of the productive value; also an autopilot system for economic processes, with which economic processes can be adopted and simplified taking into account the customer equity.

This object is achieved by a process for automatic pattern recognition with the features of claim 1, by a process for automatic control of economic processes with the features of claim 2, with an automated pattern recognition system with the features of claim 15 and by an autopilot system for economic processes with the features of claim 16. Advantageous embodiments and improvements, which can be used individually or in combination with each other, form the subject matter of the dependent claims.

The method according to the invention for automatic pattern recognition in economic processes, in particular in purchasing or distribution processes, taking into account a customer equity, which is represented by a matrix, the matrix having process-characterizing input parameters, comprises at least the following steps: a plurality of process-relevant input parameters and/or process-relevant control parameters are at least partially automatically collected with suitable data collecting means such as physical, chemical, biological or digital measuring heads; and at least one characterizing parameter is at least partially automatically determined in dependence on the input parameters and/or control parameters.

With the method according to the invention, patterns in economic processes can be recognized automatically in advantageous ways. By pattern recognition should be understood the recognition of a structure in economic processes, which relates to the customer equity.

Process-characterizing parameters are substantially customer retention, customer satisfaction, proximity to customer, capital costs, residual value, additional investments, service provision, acquisition, potential configuration, potential quality, potential quantity, etc. By using pattern recognition customer relations or an individual customer relation are quantified taking into account a productive value.

The quantification reveals the costs and the usefulness of customer relations. Both the costs and the usefulness can be purely material; they can also have, however, non-material character. Non-material usefulness and costs can also only show a material effect in the course of time.

Because of its complexity, pattern recognition occurs at least partially automatically in such a way that at least in one line of the method steps an interposition of human capacity to understand is ignored. Automation prevents subjective experiences of an individual person or a group being taken into account in the recognition of a macroscopic pattern. In this way the undesired simplification of complex connections is prevented, because according to nature the subjectivity of a single individual or of a group effects a projection of the complex issues onto simple models. A human capacity to understand can indeed be helpful, in particular in collecting data concerning economic processes; it is however the advantage of the invention that decisive steps in the pattern recognition method according to the invention occur without a human capacity to understand.

By economic processes are meant all processes in economics, in particular however purchasing or distribution processes. In such processes there are always at least two sides, which agree upon a transfer of goods, the performance of services or upon other obligations.

Customer relations are generally relations between providers of goods and services and users of these goods and services. In this sense the customer can be understood to be the provider (offerer) or also the acceptor of the offer.

The determination of a customer equity can, for example, be as appropriate for the buyer as for the seller. In this case the customer equity from the point of view of the buyer does not have to be congruent with the customer equity from the point of view of the seller, since naturally both parties generally have different interests in the buying process.

The method for automatic pattern recognition generally represents economic processes as a customer equity relevant for customer relations, wherein the customer equity does not need to be a single figure, but rather can also represent a plurality of parameters. The process-characterizing parameters are conveniently represented in matrix form, e.g. as vectors. By representing the customer equity in a matrix the complexity of the economic process is reduced to a few relevant figures, with which further decisions in the economic process can be made. A digital processing system is used for this.

By process-relevant input parameters should be understood numerous parameters which are indirectly, rather than directly, influenceable by the provider. Examples are demand, customer satisfaction, the order situation, stock market price, external circumstances which affect the sale of a product, and so on.

Process-relevant control parameters, on the other hand, are directly influenceable by the provider, such as for example the tender, the price or the quality of a product or of a service or the quality of the service, etc.

From the point of view of the person who would like to determine the customer equity, the process-relevant control parameters are influenceable by him himself, whereas the process-relevant input parameters are at least co-determined by the customer. Process-relevant input parameters can furthermore also be parameters which are dependent on neither the provider nor the customer.

Process-relevant input parameters can be for example share prices, inflation rates, exchange rates or other parameters co-determined by third parties. Principally, fiscal law can also be considered as input parameters, since it has an influence on the economic process. In other words, from the point of view of the person who would like to determine a productive value, the process-relevant control parameters are all parameters upon which he can have an influence in respect of the economic process. The process-relevant input parameters are all parameters which have an effect on the economic process, upon which he can exert no direct, rather, if appropriate, only indirect influence.

By reason of the number of process-relevant input parameters and the process-relevant control parameters a substantial data acquisition is necessary. The more data processes, the more exact the predictions for the economic process can be made. Advantageously at least 100, but rather at least 500, preferably 2500 input or control parameters respectively are automatically collected (besides optionally also manual collecting).

Depending on the process-relevant input parameters physical, chemical, biological or digital measuring heads are used. Physical parameters are, e.g., position, acceleration, speed, temperature, pressure, brightness, etc. For example, using a camera (optical sensor) the face of a customer is recorded, which is then analyzed using picture recognition. From the customer's expression, from changes in pupil size, from skin colour changes or from the temperature distribution in the face, conclusions can be drawn regarding the affections of the customer by comparison with learning curves. If the speech of the customer is recorded with an acoustic sensor, further information regarding the state of the customer's feelings can be obtained, by analyzing his speech and comparing it with references. The distribution of the sales force can be ascertained using a location sensor and a measurement for the physical presence with the customer obtained, in particular for the capacity of the sales force.

Chemical measuring heads measure chemical parameters. Chemical parameters are for example concentration of materials, pH value, material substances and so on. For example information about the state of health of cows can be determined by analysing the chemical composition of their milk.

Biological measuring heads are measuring heads such as e.g. microbes, algae, plants, animals, for which the action on a process-relevant input parameter can be determined. A person such as e.g. an interviewer can be considered as biological in so far as he acquires information about the economic process by means of suitable questions and/or observations. An interviewer is in this sense an interactive measuring head which collects targeted process-relevant input parameters.

Digital measuring heads are measuring heads which filter, by means of suitable programming, information which is significant for the process-relevant input parameters, from large amounts of data, in particular the internet. A digital measuring head is thus frequently a program which is instructed to thin out large amounts of data according to predetermined criteria and to deliver the found data to the desired place. For example a digital measuring head can be a search engine which searches the internet for given products or services or investigates the demand for a product or service or measures communication movements such as e.g. frequency of request for given services (so-called traffic).

Thus by means of the physical, chemical, biological and digital measuring heads in particular the whole spectrum of the measurable process-relevant input parameters is fully collectable.

The automation of the collecting can on the one hand relate to the selection of the collecting means such as the physical, chemical, biological and/or digital measuring heads. The choice of the measuring heads thus occurs autonomously. For example the cause of a particularly high turnover of drinks in a vending machine can be found, if particularly hot weather is established by a temperature measurement.

With the aid of a digital measuring head a surfing behavior of internet users on the homepage is investigated, so that with the knowledge of the behavior the webpage can be improved e.g. with respect to its clarity. A chemical measuring head can be selected for quality control of the product with respect to its chemical composition, in cases where the chemical quality of a product appears worthy of concern. A biological measuring head, in particular in the form of an interviewer, can then be selected, if queries can be answered by intensive requests in the framework of an interview. In this sense the automation relates to the consideration of different means of responding to questions in given queries, wherein the selection of means occurs autonomously.

On the other hand, the automation of the collecting can relate to an automatic checking of the data with respect to their quality and/or usefulness. In the case of inconsistencies or unexpected deviations of the collected data from a set value, the obtaining of additional information is automatically initiated, in order to verify the information already collected. In particular in this way the reliability of the collected data is re-checked. Several measuring heads can be employed for this purpose, which measure substantially the same thing but from different angles. An evaluation of the reliability of the collected data can be obtained from statistics. For example the quality or the usefulness of data stored from the internet can be evaluated by means of the measuring head using the web address. For example it is presumed of a database generally known as reliable that an individual piece of information which it delivers also has a high degree of reliability. On the other hand, should a piece of information be found on an unknown website, for which the reliability of the data is not guaranteed, the information is provided with a corresponding additional phrase such as “information is unsure”.

Automation can also relate to the autonomous compilation of only given data in dependence on the interesting query. For example, if deficits exist in respect of the parameter customer satisfaction and other parameters lie in the normal range, the other parameters are of less interest such as e.g. the turnover figures as a reason for the customer dissatisfaction. In this case it prompts an interviewer to go to the customer and talk to him about the reason for his dissatisfaction. Depending on which parameter is considered, a determined query catalog can be autonomously and/or independently selected. In this connection a query catalog is first compiled for each parameter. With unexpected answers or inconsistencies in the answers, additional questions are posed, i.e. interactively.

Automation in collecting effects thereby a simplification of data collecting, which is particularly important in consideration of the plurality of process-relevant input parameters. A manual input of process-relevant input parameters into the digital processing system is thus at least partially superfluous. This is then particularly convenient if lots of information is available in the internet.

In the second step of the method according to the invention a characterizing parameter is at least partially automatically determined in dependence on the input parameters and/or control parameters. In this way the plurality of process-relevant input parameters and/or process-relevant control parameters projects onto a few essential parameters. Through this compression of the data, i.e. the processing of the same, the structure of the economic process, i.e. the pattern of the economic process, comes to light. In general the mapping of respectively the process-relevant input parameters or the process-relevant control parameters onto the few parameters is a complex function, which depends individually on the economic process under consideration.

Depending on the size of the business the determination of at least one characterizing parameter can turn out to be variably complex. The parameters can be defined locally, i.e. for each business level or for each division respectively. So for a distribution employee the acquisition parameter is determined for operations from his division. For his supervisor a higher level acquisition parameter is correspondingly determined, in which the respective acquisitions of his subordinates are incorporated.

The determination of the characterizing parameters likewise occurs at least partially automatically.

By reason of the complexity of the mapping of the many process-relevant input parameters and process-relevant parameters into the characterizing parameters, a determination of the characterizing parameters by a person or a group of people is not possible, since the volume of the mass of data to be processed does not permit a quasi-manual data processing. The automation helps to manage the flow of data.

Sometimes, however, a determination of the characterizing parameter by an individual person or a group of individuals is not desired, since people tend to oversimplify complex situations. With automation, prejudices, which easily arise from people in view of the complexity, are ignored. Automation defines fixed rules, according to which the process-characterizing parameters are determined. This is particularly important if soft facts, which leave a large margin for subjectivity, must be quantified and processed. With the aid of fixed predetermined criteria, erroneous decisions based on prejudices are reduced. In this sense the method according to the invention is similar to commonly used methods in quality checking.

The method according to the invention for automatic pattern recognition in economic processes, in particular in purchasing or distribution processes, taking into account a customer equity, provides advantageously a possibility—which is at least partially independent from the interposition of human capacity to understand—of investigating process-characterizing parameters, which quantifies the value of customer relations, in particular the customer equity.

The method according to the invention for automatic control of economic processes, in particular in purchasing or distribution processes, taking into account the customer equity, which is represented by a matrix, the matrix having as entries process-characterizing parameters, comprises, using a digital processing system, at least the following steps: with suitable data collecting means such as physical, chemical, biological or digital measuring heads, a plurality of process-relevant input parameters and/or process-relevant control parameters is at least partially automatically collected; at least one characterizing parameter is at least partially automatically determined in dependence on the input parameters and/or control parameters; the characterizing parameter is compared electronically with at least one reference value; and control parameters adapted to the result of the comparison are electronically selected.

The method according to the invention for automatic control thereby comprises the data collecting as well as the data processing as described in the method according to the invention for pattern recognition. The thus determined process-characterizing parameters are furthermore compared electronically with at least one reference value. With the aid of the reference value the value of the characterizing parameter is correlated; in particular, deviations of the characterizing parameter or unexpected or undesired developments of the characterizing parameter can be identified respectively and prognoses made. The reference value is evaluated through the comparison. The comparison occurs at least partially electronically, whereby an automation is enabled.

Adapted control parameters corresponding to the result of the comparison are electronically selected. In this way influence is exerted on the economic process. The economic process is regulated.

The more input parameters collected, the more exact the assessment and the better the control of an economic process. An automatic coarse control of an individual economic process is possible, if at least 100 input parameters and/or control parameters (besides those optionally already manually collected) are automatically collected. A fine control is achieved with an automatic collecting of at least 500 input parameters and/or control parameters. A finest control is achieved with an automatic collecting of at least 2500 input parameters or control parameters respectively. The selection of the control parameters occurs at least partially electronically; thereby an automation of the control is enabled. By altering the control parameters the process-relevant input parameters are indirectly influenced. The external system, which is here formed by the customer and optionally by third parties, reacts to the selection. For example the lowering of a price generally increases the attractiveness of a product, so that the product will be bought more frequently. Turnover and sales figures increase. In the outcome other process-relevant input parameters are collected. The modified input parameters lead to modified process-characterizing parameters.

By combining the method steps data collecting, determination of the characterizing parameters, comparison of the characterizing parameters with a reference value, selection of adapted control parameters, a control loop is set up, which runs autonomously because of the at least partially automatically processing part-control-steps.

The technical problem underlying the above-cited economic problem, that of the processing of a substantial amount of data, ultimately to the exclusion of active human capacity to understand, is solved in advantageous ways by the described technical features.

In one embodiment of the method according to the invention for control one fixed reference value is provided. The reference values are for example turnover figures, figures quantifying customer satisfaction, capital costs, residual value, additional investment, service provision, acquisition, potential configuration and so on. The reference values can be fixed, in order to provide a fixed point of reference.

Preferably, according to the invention, a process history is available electronically. By means of the process history forecasts can be made regarding the future development of the process-characterizing parameters. The process history gives an overview of the past progression of the economic process, in particular the time-related progression of the customer equity.

In a further advantageous embodiment of the invention the reference value is modified in dependence on the process history. In particular, if modifications of growth rates are to be made use of, it makes sense to adapt the reference value in dependence on a process history. In this way the method according to the invention for control comprehends a large margin for reacting to unexpected modified framework conditions. For example, a disproportionately strong growth of a customer can be taken into account. The adaptation of the reference value in dependence on the process history thus permits a particularly anticipatory control of the economic process ultimately in the direction of desired target parameters.

In another embodiment of the method according to the invention for automatic pattern recognition as well as the method according to the invention for automatic control a determined query catalog is selected autonomously and/or interactively in dependence on a characterizing parameter.

In this connection a pre-setting for a query catalog is practical, which provides standardized queries via determination of a given characterizing parameter. Depending on the characterizing parameter, the query catalog is selected autonomously. In this way an unnecessary collecting of data which are not needed is avoided.

In particular cases an interactive selection is also advantageous. For example certain queries can be made if the responses to the standardized query catalog do not suffice or show inconsistencies. A request, i.e. an interactive questioning, enables respectively an increase of the reliability of the information obtained or allows information to be obtained which was not uncovered using the previous query catalog.

In an advantageous embodiment of both methods according to the invention, in dependence on interesting queries a selection of data to be collected is compiled autonomously.

If the query is provided, data can be transferred from the various areas by means of the different measuring heads. The assistance of a person is not necessary for this. For example by using keywords or a structured keyword catalog, information from the internet or other online and/or offline data sources can be gathered. The gathering of information occurs as such without the assistance of a person. Corresponding to a search engine linked to a structured keyword catalog, the digital measuring head searches through one database after another and branches via cross-references to other relevant websites or databases. If it is, for example, recognized that the weather has a notable influence on the sale of particular drinks, weather data at the respective places in question are investigated, in order for example to choose the corresponding spectrum of drinks offers. In this instance the assistance of a person is likewise not necessary.

In a practical embodiment of the method according to the invention for automatic control the reference value is determined from the process history by means of a self-learning algorithm. The self-learning algorithm reduces the probability of a repetition of errors already made in the past.

A self-learning algorithm can also be appropriate if the process-characterizing parameters are compared with a reference value, in order to choose a process-relevant parameter using the result of the comparison. By using the process history it can be checked which of a number of process-characterizing parameters is particularly important for the economic process and which must be particularly taken into account in selecting the process-relevant control parameters. For example, an increase in customer satisfaction at a time when through customer relations only disadvantages must be accepted makes no sense. The other process-characterizing parameters must be correspondingly more heavily weighted. A self-learning algorithm reduces the probability that the control repeats an error. The self-learning algorithm is in a position to react in a reasonable way to the complexity of an economic process.

In a further advantageous embodiment of both methods according to the invention the measuring heads used are selected autonomously in dependence on interesting queries. Sometimes the same thing can in principal be measured with several measuring heads, wherein the measuring heads differ in respect of their measurement precision. By reason respectively of the different measurement precision or the different reliability of the measuring heads it is sensible to select a measuring head correspondingly. Furthermore, only particular measuring heads are suitable for particular queries. For example the collecting of temperature at a location is possible using a directly installed measuring head; the temperature can also possibly be requested over the internet from the weather service. In this case, both solutions to the problem are equally acceptable. On the other hand a physical measuring head is not suitable for requesting a stock price. The relevant information must be requested at the stock exchange or over the internet by means of a biological measuring head in the form of a person or by a digital measuring head. A query over the internet is much simpler and more cost-effective than a telephone call. In this case a digital measuring head makes more sense than a biological measuring head.

In a particular embodiment of both methods according to the invention the at least partially automatically collected data are checked with respect to the quality and/or the usefulness. Even with soft data, it is important to know from which source the data comes, in order to be able to correctly classify the data. By specifying a reference list, for example reliable data sources, which are known for a good quality, can be listed and distinguished from less reliable data sources. By means of such a list collected data can be provided with an appendix, which gives information about the reliability, the quality or the usefulness of the information. The respective quality or usefulness check can also comprise a comparison of the data with data from the process history. Large or unexpected discrepancies can point to the data lacking in quality.

In a special embodiment of both methods according to the invention, the process-characterizing parameters are substantially customer retention, customer satisfaction, proximity to customer, capital costs, residual value, additional investments, service provision, acquisition, potential configuration, potential quality, potential quantity. For practical purposes, the characterizing parameters are simple figures, which are optionally given with probabilities or variants. They are more closely defined in the following:

The acquisition is characterized in that it synchronizes the distribution process of the provider (the seller) and the acquisition process of the client (the purchaser). During the acquisition, customer and provider generally enter into a phase of two-way interaction. The acquisition process comprises the project acquisition, the request, the offer, the contract and the execution.

The proximity to the customer comprises substantially two aspects: the proximity to the customer of the service spectrum and the proximity to the customer of the interaction behavior.

The proximity to the customer of the service comprises the product and service quality, which depends on the frequency of shortfalls with respect to the quality demands of the customer, the perceived product quality, the frequency of occurrences of complaint cases and on the perceived service quality; it comprises the quality of the customer-related processes, which depends on the compliance with agreed dates with respect to customers, on the absence of friction in the course of routine processes, the cost in connection with the course of routine processes and perceived delivery reliability; it comprises the flexibility regarding contact with the customer, which depends on the ability to carry out economically desired modifications even long after award of contract, on specific wishes regarding products to be delivered, on specific wishes with regard to delivery dates and on pricing; it comprises the quality of the advice from the seller, which depends on the interest in the customer's problems, on the interest in the use of the product by the customer, on the objectivity of the information of the customer, on the objectivity of the advice of the customer, on the information of the customer with regard to the products' performance limits.

The proximity to the customer of the interaction behavior is determined by the quality of the advice from the provider (seller), which is dependent on the interest in the problems of the customer, on the interest in the use of the products by the customer, on the objectivity on the information from the customer with regard to the performance limits of the products; it is determined by the openness in the information behavior with regard to the customer, which depends on the information over measures which affect the customer, on early information regarding planned changes to company policy, on early information over planned changes to product programs, and on information concerning strategic thinking; it is determined by the openness with respect to proposals from the customer's side, which depends on the value which the provider places on the opinion of the customer in basic questions of company policy, on the inclusive participation of the client in product development, on the openness to suggestions or process optimization of the provider, on the fast reaction to proposals; it is determined by customer contact with personnel not active in sales, which depends on regular customer contact with management, on regular customer contact with employees in the production division and on regular customer contact with employees from the development division.

Customer satisfaction is the result of a “should- and is-comparison” of the customer expectations, which depends on experiences, business communication, verbal propaganda and needs, with the performances experienced. Should the expectations be fulfilled or even surpassed, customer satisfaction results, which leads to verbal propaganda or customer loyalty. If expectations are not fulfilled, this results in customer dissatisfaction, which effects no reaction, complaints, unfavourable verbal propaganda or a movement away. Customer retention is co-determined with customer loyalty, which is dependent upon acceptance, trust and positive engagement with the customer. Customer retention is dependent on customer sales, cross-buying and recommendation.

Two alternative models are available for determining residual value. On the one hand, one can equate residual value with a theoretical liquidation value at the end of the strategy lifetime. This appears particularly sensible if the strategy is characterized by a targeted de-investment and a skimming off of past acquired competitive advantages. This process also presents itself if one has to start from very unstable market relationships. On the other hand, the possibility exists of starting from stable market relationships at the end of the planning period and of fixing a given cash flow for the residual value period in the sense of a permanent annuity. The starting parameters for calculation of cash flow are the incoming payments (turnover) from a customer relation. To be subtracted herefrom are outgoing payments, such as for example for staff, operational expenditure, investments and payment of taxes. The remaining residual value is termed operating cash flow, which is used, for example, for financing the broadening of potential. Net cash flow is obtained by subtracting investment in the future from the operating cash flow. The free cash flow is obtained by considering necessary interest payments, where applicable.

The future cash flow can accordingly be calculated by the combination of the essential value drivers. The essential value drivers are: turnover from the previous year, turnover growth rate, operational profit margin, cash-profit, taxation rate, additional investment in fixed assets, additional investment in liquid assets, duration of the growth in value (period under consideration). The cash flow for each period of the period under consideration can be calculated according to the following formula:

$$\begin{matrix}Cash flow = incoming payments - outgoing payments \\ = [ ( previous year turnover ) * ( 1 + turnover growth rate ) \\ ( achieved profit margin ) * ( 1 - cash \text{-} profit taxation rate ) ] + \\ ( additional investment in fixed assets + \\ additional investment in liquid assets ) .\end{matrix}$$

The capital cost unit rate serves to discount future cash flows and thereby reduce them to the present value. It is made up of the weighted mean of the costs of outside and own capital. Outside capital costs are relatively simple to determine, since generally a fixed interest rate and repayment rate is agreed with the lender. Since interest repayments are tax deductible, the rate of return which must be generated on the outside capital corresponds to the outside capital costs of the tax. The determination of own capital costs is somewhat more difficult. Generally no fixed rate of return is agreed with the proprietors. The proprietor is therefore more at risk in the acquisition of share certificates than a lender. This must be taken into account in the capital cost unit rate in the form of a risk premium. In any case the proprietor has expectations with respect to a rate of return to be achieved, otherwise an interest in the acquisition of share certificates or the holding onto of share certificates would not be justified. The own capital costs are therefore made up of a risk-free interest rate which generally corresponds to the current interest rate of a secure investment, and a risk premium of the owned capital.

The potential configuration describes which potentials are available on the side of the customer and which potentials are available on the side of the provider. Potentials for the customers are, for example, the needs potentials of the present and future but also know-how, development and reference potentials should be considered. The customer needs potential in industrial business is frequently closely linked to the demands and needs of the downstream customer groups, the so-called customer's clients. For example, if the customer's clients market grows, this will also have the effect on marketing potential of the customer, which can in turn increase the marketing potential of the provider. The potential of the provider can be best described as their competence and readiness to solve the current and potential problems and tasks of the customers. This includes specifically product performances, but also service and innovation performance. By providing potential should also be understood secondary potential, such as employee qualification, capital resources, production installations and development capacity, which create the conditions for the creation of a service package.

A transaction process consists of three sub-processes, namely the potential configuration, the acquisition and the goods and services. Depending on whether a first purchase, a repeat or a serial purchase is concerned, the content definition, the expenditure and the individual work steps differ in these phases. The sub-process of determination of the potential configuration delivers as essential result a clear and evaluated idea as to with what and how a best possible customer equity can be realized. Only on this basis can the sub-process of acquisition be sensibly conceived and successfully designed.

The activity compilation process includes the phases preparation of goods and services, production, dispatch, optionally montage of the product and the service performance associated with the product. Research and development, accounting and materials administration do the preliminary work for the individual phases. In the goods and services process the non-material contractual content agreed between the customer and the provider is converted into products and product characteristics which are mostly material and therefore tangible. The potential configuration process is to a large extent information-critical, while the acquisition process is above all success-critical. The goods and services process on the other hand is principally result-critical. Disturbance variables are, e.g., inexact contractual agreement, inadequate pre-calculation, unforeseen changes to the starting situation, disturbances of the process flow, technical deficits and unarticulated customer expectations not picked up on by the provider.

Each transaction concludes at the end of the activity compilation process with a result. The evaluation in turn forms the starting point for the potential configuration process, so that altogether the transaction process can be understood with its three sub-processes as a potentially repeatable cycle in itself.

In an advantageous embodiment of both methods according to the invention the customer equity is shown on a display. By means of the display the customer equity and thereby the pattern of the economic process is presented. It is practical to direct the display to the receiver's horizon, in particular to the business leadership's far-reaching competences and give more detailed forecasts over a broader range to individual employees at a lower level of the business.

In a special embodiment of both methods according to the invention, the customer equity is determined continuously or at predeterminable time intervals. In particular through the continuous online inquiry, processes are recorded precisely in chronological progression. Possible developments can be recognized ahead of schedule and business maxims can be provided timely.

In an advantageous embodiment of both methods according to the invention the customer equity is consulted as a basis for an early warning system. With the early warning system, possible risks can advantageously be identified early and comparatively comprehensively.

A comprehensive risk management system can be structured in the following parallel sub-systems: internal surveillance system (reliability of operational processes and data); controlling (target-oriented coordination); early warning system (timely recognition of dangers and counter-controls).

Risk identification, risk evaluation and risk control are the objects of the risk early warning system. A complex risk management cannot be operated by means of detailed guidelines (e.g. comprehensive control measures). A substantial challenge to risk management lies in the formation of intelligent feedback systems, which e.g. accompany the process of employees' attitude change. Intelligent, self-controlling systems have an above average high degree of effectiveness and are more capable of adapting with respect to environmental changes and with increasing benefit than a rigidly provided system. Moreover, consequences arise for organizational coordination and reporting. Risk management must become an integral component of the processes in which the risks arise. Furthermore, the identification and evaluation of the risks, the selection and implementation of countermeasures are the tasks of the “process owner”. A risk-oriented reporting must guarantee risk communication.

The early warning system should help to recognize dangers timely. In risk identification is asked, how high the real net output ratio is, the turnover, the return and sales, the customer potential, the innovation strength, or the customer creditworthiness, or how strongly the customer is globalized, or respectively how the quality of the collaboration is. The responses to these questions are provided with a corresponding coefficient which quantifies the possibilities of the responses.

The risk analysis includes a decided investigation of the risks identified in the framework of the company activities with respect to their causes and effects. The risk analysis further forms the basis for the risk evaluation, in which the dimensions “magnitude of missing the target” and “entry probability” occupy central positions. Consequently, for the evaluation of the loss potential, both the degree of damage, i.e. the magnitude of the loss on occurrence of an event, as well as the predictability, the probability of the event occurring, should be determined.

In the risk analysis risk factors may not be considered in isolation. Rather, their interdependences should be taken into account, since often a significant effect in respect of the target system of a business would not be expected from an individual factor, and only an unfavorable compounding of several risk factors can lead to a serious threat.

In this context existence and effect relations should be distinguished. While the first category investigates which factors appear respectively coupled or as mutually exclusive, in the second group it is a question of the influence of the type and intensity of a parameter on one or more other risk variables. Logical causal existence connections can in this way be effected, so that two risk factors either mutually exclude each other or appear together, wherein respectively a two-way coupling or a (single-sided) conditional connection exists. Non-logical causal existence connections structure themselves in pure chance constellations as well as facultative connections.

Instruments to be used in risk control are on the one hand risk avoidance (omission of a risky operational activity), risk reduction (reduction of the probability of occurrence of damaging events or reduction of the magnitude of a loss), risk analysis (segmentation of a risky activity into partial activities, in order to achieve diversification effects), risk transfer (shifting, passing risk to market partners or insurances), risk acceptance (conscious acceptance and optionally protection by reserve-building).

The automated pattern recognition system according to the invention for economic processes, in particular in purchasing or distribution processes, taking into account a customer equity, which is represented by a matrix, the matrix having process-characterizing input parameters, has a digital processing system, data collecting means such as physical, chemical, biological or digital measuring heads, for at least partial automatic collecting of a plurality of process-relevant input parameters and/or process-relevant control parameters, and pattern determining means for at least partial automatic determination of at least one characterizing parameter in dependence on the input parameters and/or control parameters.

The data collecting means can be for example a simple measuring head, or also an intelligent measuring head, which checks the quality and the usefulness of the collected data by means of a suitable control technique and optionally carries out further queries or additional measurements.

The pattern determining means determine at least one characterizing parameter from the collected data at least partially automatically. In this way the result of the pattern determining means can be used to effect a re-collecting of data by means of the data collecting means, in cases with distinctive features or inconsistencies or unexpected discrepancies. If, for example, a process-characterizing parameter unexpectedly deviates from a target value, it will be verified by a feed-back that the data collecting as such has occurred correctly. The feed-back can also comprise the posing of additional, i.e. other, queries by the data collecting means. With the help of the additional queries additional information is compiled.

In this sense the automated pattern recognition system rests on two feed-back cycles. The first feed-back cycle is situated within the data collecting means and thereby tracks down “local” inconsistencies in the collected data. The second feed-back cycle takes into account the result of the pattern recognition. It therefore applies to “global” parameters such as e.g. process-characterizing parameters.

If for example a physical parameter such as temperature is only imprecisely measured because of a poor signal-to-noise ratio, the internal feed-back cycle, i.e. the feed-back cycle in the data collecting means, effects a secondary measurement for verification.

If it is ascertained that a given parameter, such as customer satisfaction, deviates from a target value, the pattern determination means activates the collecting of additional data from the data collecting means. The finding of the deviating parameter is either corroborated or placed in doubt by the additional data.

The autopilot system according to the invention for economic processes, in particular for purchasing or distribution processes, taking into account a customer equity, which is represented by a matrix, the matrix having process-characterizing input parameters, comprises a digital processing system, data collecting means such as physical, chemical, biological or digital measuring heads, for at least partial automatic collecting of a plurality of process-relevant input parameters and/or process-relevant control parameters, pattern determining means for at least partial automatic determination of at least one characterizing parameter in dependence on the input parameters and/or control parameters, a comparator for comparing the characterizing parameters with at least one reference value, and a selector for selecting control parameters adapted to the result of the comparison.

Since the pattern recognition system according to the invention can be a component of the autopilot system, all features which were introduced in the context of the pattern recognition system are also transferable to the autopilot system.

The characterizing parameter is compared with a reference value by means of the comparator. Maxims for the further performance of the economic process can be derived from the comparison result; in particular adapted control parameters are selected by means of the selector. The economic process reacts to the modification of the control parameters, whereby the process-characterizing parameters modify themselves. The autopilot system engages in the economic process in a regulating way through the modification of the control parameters.

Since each process step of the autopilot system or the pattern recognition system occurs at least partially automatically, at least parts of the economic process can be handled autonomously.

The autopilot system is particularly important against the background of an early warning system, with which risks and opportunities of an economic process can be recognized or prevented or used, in advance. The autopilot system can e.g. be supported through workflows.

The autopilot system can be used in the framework of an early warning system, in order to avert in advance the development of damage to the company or to use opportunities which are available to the company. The most important control parameters, which must indispensably be brought under control and maintained for the viability of the company, are the strategy, success and liquidity parameters. The control parameter risk influences the remaining control parameters in the operative as in the strategic domain. The distinction between the individual control levels and the increasing complexity of the respective fundamental orientation principles is essential.

In order to broaden the control horizon into the future, an entirely different control level must be developed. A sensible risk management happens on at least two levels: the strategic level, which is accompanied, by reason of the long planning period, with a high degree of complexity; and the operative level for short-term risk control.

The autopilot system is used as navigation assistant in the company. The current risk situation is collected by means of the process-characterizing parameters determined by the pattern recognition system. Starting from the key performance driver, the thereto-pertaining processes can now be directly controlled.

In a preferred embodiment of both systems according to the invention the customer equity is shown on a display. The display shows, for example: the capital costs, which show, among other things, the general rate of return expectation, the risk premium and the specific rate of return expectation; the cash flow, which includes a scenario account, a pre-calculation, a concurrently running calculation and a closing calculation; the additional investments, which comprise respectively the investments in the liquid assets and the investments in the fixed assets; the so called CAI (Customer Asset Index), which evaluates the proximity to customers, customer satisfaction and customer retention; the potential, which refers to the current potential and to the future potential.

Decisive information regarding the economic process and the business is displayed by means of the six characteristics presented here. With this information a contractor or a member of a business can, in a simple way, obtain an overview of the present situation of the business or the economic process, and in particular draw conclusions regarding future decisions.

In an advantageous embodiment of both systems according to the invention, a query catalog generator is provided, which selects autonomously and/or interactively a determined query catalog in dependence on a characterizing parameter. Thus with the query catalog generator, only queries relevant for the characterizing parameter under consideration are posed.

In a further advantageous embodiment of the invention, a data accumulation means is provided for autonomous compilation of a selection of data to be collected in dependence on interesting queries. In this way, upon an interesting query, data are compiled autonomously by the system. This can occur for example by a digital measuring head searching in particular the internet for information pertaining to the query posed. In this way the search progression can be dependent on the information from the search result. In particular an associative response to the query enables an unknown and broad spectrum of responses. By means of the data accumulation means queries can be re-formulated after receipt of their response, in order to receive more detailed or further-reaching information in the association spectrum of the query. The data accumulation means adapts a subsequent query according to the response to the previous query.

In a special embodiment of the invention a measuring head selection means is provided for autonomous selection of the applied measuring heads in dependence on interesting queries. For example stock market prices are preferably downloaded from the internet by a digital measuring head and not requested by means of an interviewer calling the stock exchange or a bank.

It can make sense with some queries to activate several measuring heads to answer queries at the same time, in order to obtain responses to a question from different perspectives. The system according to the invention is advantageously provided with a data checking means for checking the quality and/or usefulness of the at least partially automatically collected data.

The data checking means assure that the measured or respectively determined or collected data are of acceptable quality or usefulness. This can be achieved by the data being compared with reference values or expected values respectively, so that in the case of unexpected discrepancies further queries or a renewed measurement are carried out. The data, which are determined in particular by physical or chemical measuring heads, are often superimposed by noise, so that upon recognition of a favorable signal-to-noise ratio a renewed measurement or collecting of the data makes sense.

Advantageously the system has at least one output means for output of queries, of information, of goods such as prepaid cards or similar gifts, and/or for provision of services such as credits and/or expressions of apology by means of voice-mail, E-mail, SMS, letter or the like, to the customers. A service can thus be to provide the customer with particular information. Goods can be presented to the customer in the form of a gift or a credit. The output can occur for example by means of an SMS message, a telephone message, an E-mail or a bank transfer.

In the following, applications of the pattern recognition system and the autopilot system are given by way of example:

It is known that a number of cellular (mobile) telephone conversations are respectively interrupted or cut off. The reason lies in technical difficulties which arise from an incomplete or perturbed mobile telecommunications network. An accumulation of such incidences leads to an increased dissatisfaction of the cellular telephone user. The problem of perturbed telecommunications connections is, for economic reasons, not completely solvable at this time.

In respect of an optimization of the customer equity, the subjective perception of this technical defect could, however, be influenced to the effect that customer dissatisfaction is limited and customer satisfaction increased. Increased customer satisfaction is expressed in increased acceptance on the customer's side. Increased acceptance results in an increased emotional attachment of the customer.

In order to create the conditions for such an influencing of customer relations, an event of this type must be designed in an economically efficient way. Automation is necessary for this.

For example, the termination of a telephone call is registered automatically. The termination is registered by a digital measuring head and collected by the processing system as a process-relevant input parameter. The occurrence of the termination sets off a chain of reactions in the processing system.

For example, a further digital measuring head as personal digital assistant compiles customer data. The customer data comprise information regarding which client is concerned, what turnover this customer is achieving, what is the basis amount of conversation and/or conversation profile, which terminations have thus far occurred, which general or customer specific advertising has been undertaken, which targets e.g. the corporate client adviser pursues with this client and so on.

These customer data describe the process-relevant control parameters in generally formulated form.

The client in this context represents the external system. The digital processing system with the pattern determination means selects automatically in the following, by means of production plans and capacity planning deposited in the system including alternative scenario process objects and/or process content, which have the target respectively of assuring the customer and his productive potential or of optimising the result which can be achieved with this customer.

With this analysis carried out by the pattern recognition system or with the pattern which relates to individual customers' customer relations, further decisions can be taken regarding the manner of further proceeding with the customer.

The autopilot goes a step further than the pattern recognition system, in that it makes comparisons with reference values by means of a comparator and selects appropriate working processes and approaches by means of a selector. The working processes and approaches describe the control parameter. The autopilot relays, via the output means, corresponding queries, information, expressions of apology e.g. via E-mails, SMS messages, letters, spoken messages, telephone messages (so called voice mail) and so on, either directly to the customer and/or to the respective competent service facilities or by proposing selected activities to the employees in sales, distribution, marketing or services, which optimize the customer equity. The autopilot can itself preferably also actively participate, in that it can approach the customer and, for example, deliver him a credit.

By means of such measures the autopilot assures that suitable and appropriate action is taken based on the respective task and the respective customer. It relates the costs of customer relations to their use. It generates a practised proximity to customer and aims for an improved customer satisfaction, wherein the autopilot itself functions as efficiently as possible by means of the automation.

The problem of the termination of a cellular telephone conversation cannot be solved by the pattern recognition system and the autopilot, but the dissatisfaction of the customer over a termination can be restricted to ways which are, by means of the automation, economically compatible. In this way a customer retention is achieved in an advantageous way.

Further advantageous embodiments and features, which can appear individually or in combination, are more closely illustrated by means of the following figures.

The figures should not be construed as limiting the invention but should rather exemplify the invention.

The figures show, schematically:

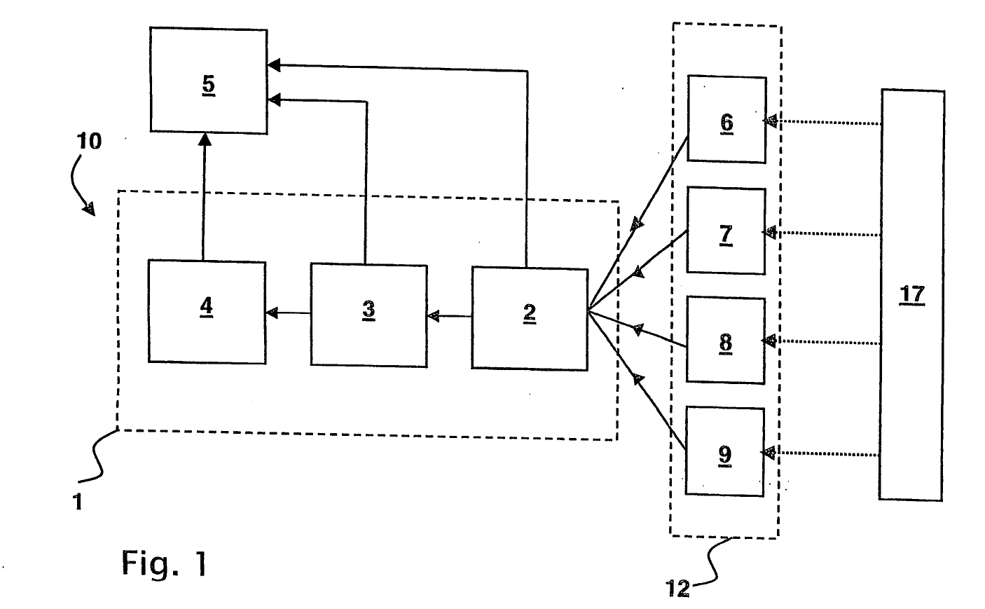

FIG. 1 a pattern recognition system according to the invention;

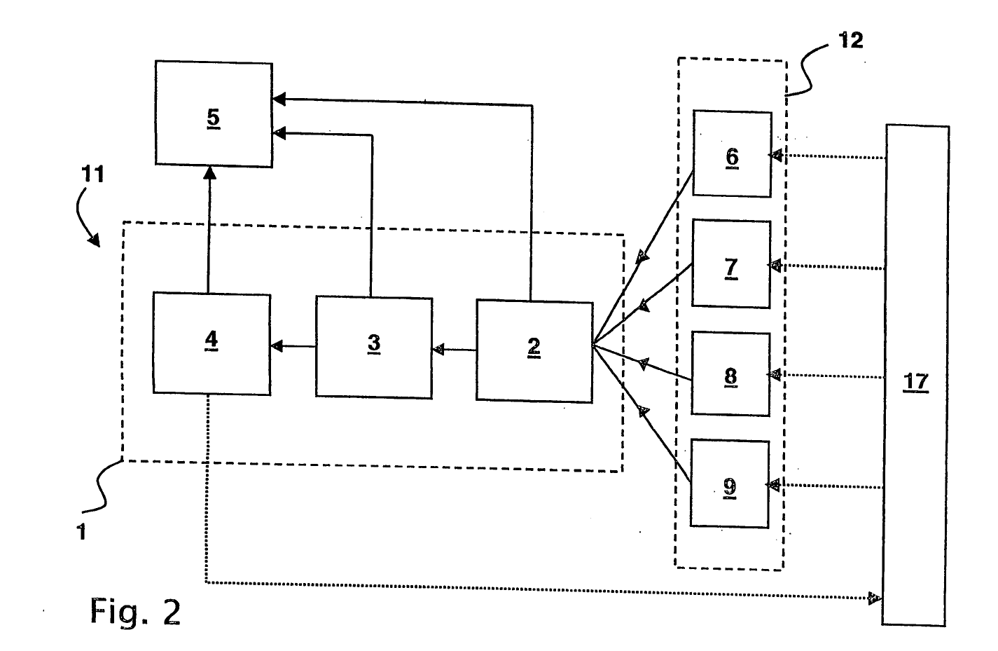

FIG. 2 an autopilot system according to the invention;

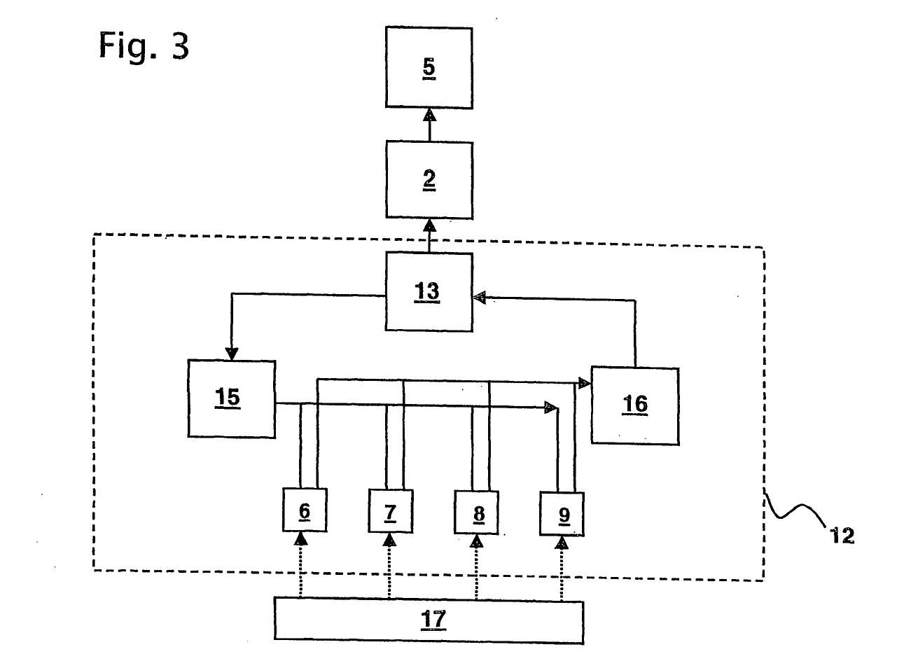

FIG. 3 a pattern recognition system according to the invention with a feed-back for checking the data;

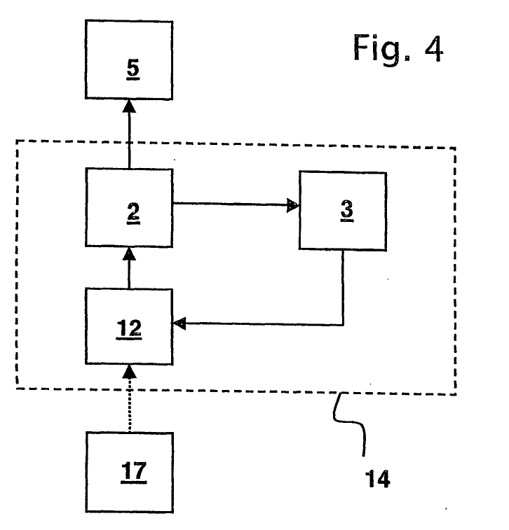

FIG. 4 a pattern recognition system according to the invention, with a feed-back taking into account the result of comparison of the determined process-characterizing parameters with the reference values;

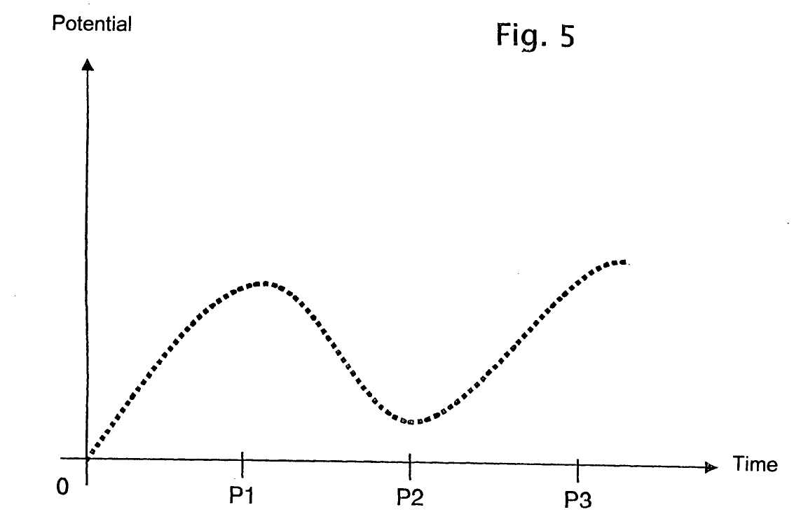

FIG. 5 the plot of transaction process against time; and

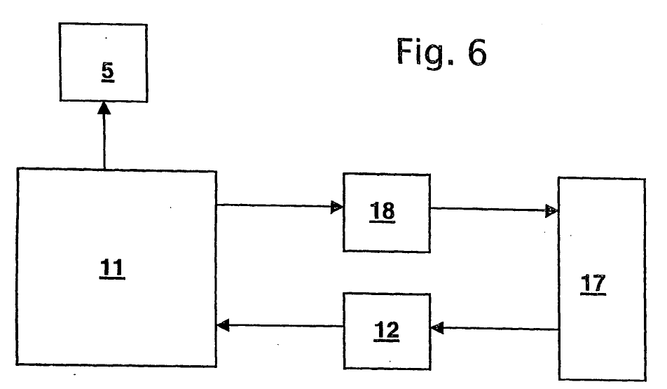

FIG. 6 a further autopilot system according to the invention.

FIG. 1 shows a pattern recognition system according to the invention, for economic processes, in particular in purchasing or distribution processes taking into account a customer equity, with a digital processing system 1 and data collecting means 12. The data collecting means 12 comprise a chemical measuring head 6, a physical measuring head 7, a digital measuring head 8 and a biological measuring head 9. The chemical measuring head 6 measures the chemical composition of a product, for example a chemical liquid. The physical measuring head 7 measures a given temperature in the production process of the product. A digital measuring head 8 collects the queries regarding the product with potential customers. The biological measuring head 9 in the form of an interviewer questions the customer concerning his product needs. Measuring heads 6 to 9 thereby collect information concerning an external system 17, which is defined by the economic process. Arrows in the illustrations represent the direction in which the substantial information flow flows between the individual components. The digital processing system 1 comprises pattern determination means 2, a comparator 3, a selector 4 and a display 5.

By means of the pattern determination means 2, process-characterizing parameters are determined from the data collected by data collecting means 12. These parameters are for example the capital costs, the cash flow, the additional investments, the CAI, the success rate and the customer potential. The thus obtained characterizing parameters are compared with a reference value. For example, if the success rate only amounts to 25% instead of the desired 50%, this discrepancy is displayed on screen 5. If the additional investments are much higher than expected, the discrepancy is likewise displayed and the business management or the employees in a division warned. Display 5 displays the comparison results, as well as proposed modified control parameters and the determined characterizing parameters. In this context it is important that for each measured parameter a determined value in the form of a defined unit is assigned, with which a further processing of the information is possible. Soft factors are represented by probabilities.

The input parameters for the economic process are mapped to process-characterizing parameters by the pattern recognition system 10. In this way the complexity of the economic process, in particular of the external system 17, is reduced and mapped to useable classification parameters, as the process-characterizing parameters show. The mapping or the projection occurs automatically, i.e. data can be processed much more comprehensively and in more detail than previously possible. Automation renders, at least partially, human intervention during the pattern recognition no longer necessary. Erroneous decisions on the basis of subjective interpretations of individuals or a group of individuals are reduced.

FIG. 2 shows an autopilot system 11 according to the invention, for automatic control of economic processes, in particular of purchasing or distribution processes, taking into account the customer equity. The autopilot system 11 comprises a digital processing system 1 and data collecting means 12 as in the pattern recognition system 10 according to the invention; however the modified control parameters are offered to the economic process, whereupon the economic process reacts to the modified control parameters by means of modified input parameters. Modified input parameters are correspondingly determined by measuring heads 6 to 9. By comparing the characterizing parameterss with predetermined reference values and with the selection of adapted control parameters, a feed-back is achieved, which leads to a control of the economic process. The reference value is e.g. adapted to the process history and thereby not rigidly predetermined. Corresponding to the development of the economic process in the preceding time, the control parameters are suitably adjusted in order to allow for the temporal development of the economic process. The selector 4 has a suitable self-learning algorithm, which is capable of learning from past errors.

FIG. 3 shows a pattern recognition system 10 with a feed-back for checking the collected data with respect to its quality and its usefulness. Thus data collecting means 12 comprises, in addition to the measuring heads 6 to 9, a data checking means 16 which checks the collected data for example with respect to their reliability. The reliability of a physical measurement is for example determined by the signal-to-noise ratio. With digital measuring heads 8, which e.g. search for specific information in the internet, a reliability value is assigned to the respective data source or database. The result of the data check by data checking means 16 is forwarded to query catalog generator 13. Query catalog generator 13 poses further queries, in order to investigate additional information for unsatisfactorily answered queries. A measuring head selection means 15 makes a suitable selection of the respective measuring heads 6 to 9, which can be considered in answering queries. Then the same or other measuring heads 6 to 9 collect the response to the modified query, wherein information from the external system 17, which is represented through the economic process, is collected.

It is also conceivable that the data checking means 16 are directly arranged at each individual measuring head 6 to 9, so that for each measuring head 6 to 9 individual checking of respectively the quality and the usefulness of the data takes place. If the queries are sufficiently satisfactorily solved or if no solution is reached even with repeated queries, the data are passed from data collecting means 12 to pattern determining means 2, which determines process-characterizing parameters from the data and displays these on display 5. If no satisfactory response to a query is found, the query catalog generator 13 or the data collecting means 12 in general sends a signal to pattern determining means 2, which states that there is not a correct answer to the query.

FIG. 4 shows a pattern recognition system 10 with data accumulation means 14, which has the task, after a collecting of data and a determination of the process-characterizing parameters, of posing additional queries in the case of unexpected values of the characterizing parameters, which queries should be answered by data collecting means 12. For example, should it emerge that a characterizing parameter strongly deviates from the target value in comparison with its process history or in comparison with another parameter, the comparator 3 sends a signal to data collecting means 12 stating that detailed information is necessary. Hereupon data collecting means 12, for example with the aid of a query catalog generator 13 (not pictured here), poses additional queries to the external system 13. Display 5 thereby presents the process-characterizing parameters determined by queries, wherein the feed-back occurs via the process-characterizing parameters. Data collecting means 12 according to FIG. 4 includes a feed-back on the level of the determined data as such. The feed-back loop (depicted with arrows) thereby occurs before the determination of the process-characterizing parameters. Arrows in the figure thus represent the direction in which the substantial information flow flows between the individual components.

FIGS. 3 and 4 thus show a pattern recognition system 10 with feed-back loops, which lie on different levels. The feed-back loops themselves show at least partial automation. FIG. 2 shows an autopilot system 11 with a feed-back which occurs via the demand of modified control parameters with the external system 17. The embodiments described in FIGS. 1, 3 and 4 can of course also be used analogously with autopilot system 11.

All feed-back loops described can be shut off by means of different termination criteria. For example a feed-back is terminated after at most 20, in particular after at most 10, preferably after at most 3 iterations. Alternatively the feed-back is terminated if the feed-back parameter converges towards a certain value within a given selectable window. If it is found that the feed-back diverges, it is likewise terminated and a corresponding signal relayed.

FIG. 5 shows schematically a transaction process, wherein exemplarily the customer satisfaction potential is plotted against time. At time 0 the customer is neutral with respect to the provider. The potential is correspondingly at 0. By communication with the customer and pricing of the products the customer's interest in the provider's goods increases. At sale closure (P1) the customer is satisfied with the product and the potential is at its highest point. After sale closure resistance and scepticism grow on the side of the customer, which e.g. arise in connection with the product. The customer satisfaction decreases (P2). For example the product necessitates some familiarization. Through the provider working to convince the customer, for example by means of particular services or by means of making available further information about the product, customer satisfaction increases and the potential increases (P3).

As recognized, customer satisfaction follows an up and down path, the time plot of which can be determined by means of a customer equity. This development is anticipated by the pattern recognition system, so that timely corresponding measures can be taken. The pattern recognition system thereby delivers information about the economic process, which can serve as guidelines for further decisions.

The autopilot system goes one step further and uses this information to apply measures, which effects a particularly advantageous development of the economic process. In particular several economic processes can be processed simultaneously.

FIG. 6 shows a further autopilot system 11 according to the invention, with a display 5, data collecting means 12 and output means 18. The output means 18 have the purpose of dispensing in particular goods and/or services to the customers. For example if a customer is supplied with certain information via the output means, he receives gifts or a credit via a sum of money or he is offered another promotion. The output can for example occur by means of an SMS message, a telephone message, an E-mail or a bank transfer.

The invention concerns a method for automatic pattern recognition in economic processes taking into account a customer equity, using a digital processing system 1, whereby a number of process-relevant input parameters and/or process-relevant control parameters are at least partially automatically collected with suitable data collecting means 12, such as physical, chemical, biological, or digital measuring heads 6 to 9 and whereby at least one characteristic parameter is at least partially automatically determined, based on the input parameters and/or control parameters.

The invention also relates to a method for automatic control, using the characteristic parameters as determined, which carries out an electronic selection of the control parameters, corresponding to the result of a comparison, from comparing the characteristic parameter with at least one reference value, which for its part has an influence on the economic process, such that an automatic regulated loop is achieved. The invention further relates to a pattern recognition system 10 and autopilot system 11 corresponding to the above method.

The invention is advantageously characterized in that complex relationships, such as are usual in economic processes, can be at least partially automatically collected and processed, such that at least a part of the economic process can be regulated whilst taking into account the customer equity. The invention permits an objective evaluation of process-relevant input parameters, without the subjective interpretations of an individual influencing the results of the pattern recognition or the automatic control.

### List of Characters

1 digital processing system
2 pattern determination means
3 comparator
4 selector
display
6 chemical measuring head
7 physical measuring head
8 digital measuring head
9 biological measuring head
pattern recognition system
11 autopilot system
12 data collecting means
13 query catalog generator
14 data accumulation means
15 measuring head selection means
16 data checking means
17 external system
18 data output means

1. Method for automatic pattern recognition in economic processes, in particular in purchasing or distribution processes, taking into account a customer equity, which is represented by a matrix, the matrix having process-characterizing input parameters, using a digital processing system, which comprises at least the following steps:
at least partial automatic collecting of a plurality of process-relevant input parameters and/or process-relevant control parameters with suitable data collecting means such as physical, chemical, biological or digital measuring heads;
at least partial automatic determination of at least one characterizing parameter in dependence on the input parameters and/or control parameters.

2. Method for automatic control of economic processes, in particular in purchasing or distribution processes, taking into account the customer equity, which is represented by a matrix, the matrix having process-characterizing input parameters, using a digital processing system, which comprises at least the following steps:
at least partial automatic collecting of a plurality of process-relevant input parameters and/or process-relevant control parameters with suitable data collecting means such as physical, chemical, biological or digital measuring heads;
at least partial automatic determination of at least one characterizing parameter in dependence on the input parameters and/or control parameters;
electronic comparison of the characterizing parameters with at least one reference value;
electronic selection of the control parameters adapted to the result of the comparison.

3. Method according to claim 2, wherein the reference value is fixed.

4. Method according to claim 2, wherein a process history is available electronically.

5. Method according to claim 4, wherein the reference value is modified in dependence on the process history.

6. Method according to claim 5, wherein the reference value is determined from the process history by means of a self-learning algorithm.

7. Method according to claim 2, wherein in dependence on a parameter a determined query catalog is selected autonomously and/or interactively.

8. Method according to claim 2, wherein in dependence on interesting queries a selection of data to be collected is compiled autonomously.

9. Method according to claim 2, wherein the measuring heads used are selected autonomously in dependence on interesting queries.

10. Method according to claim 2, wherein the at least partially automatically collected data are checked with respect to their quality and/or their usefulness.

11. Method according to claim 2, wherein the process-characterizing parameters are substantially the following parameters: customer retention, customer satisfaction, proximity to customer, capital costs, residual value, additional investments, service provision, acquisition, potential configuration, potential quality, potential quantity.

12. Method according to claim 2, wherein the customer equity is shown on a display.

13. Method according to claim 2, wherein the customer equity is determined continuously or at predetermined time intervals.

14. Method according to claim 2, wherein the customer equity is consulted as a basis for an early warning system.

15. Automated pattern recognition system for economic processes, in particular in purchasing or distribution processes, taking into account a customer equity, which is represented by a matrix, the matrix having process-characterizing input parameters, with
a digital processing system;
data collecting means such as physical, chemical, biological or digital measuring heads, for at least partial automatic collecting of a plurality of process-relevant input parameters and/or process-relevant control parameters; and
pattern determining means for at least partial automatic determination of at least one characterizing parameter in dependence on the input parameters and/or control parameters.

16. Autopilot system for economic processes, in particular in purchasing or distribution processes, taking into account a customer equity, which is represented by a matrix, the matrix having process-characterizing input parameters, with
a digital processing system;
data collecting means such as physical, chemical, biological or digital measuring heads, for at least partial automatic collecting of a plurality of process-relevant input parameters and/or process-relevant control parameters;
pattern determining means for at least partial automatic determination of at least one characterizing parameter in dependence on the input parameters and/or control parameters;
a comparator for comparing the characterizing parameters with at least one reference value; and
a selector for selecting control parameters adapted to the result of the comparison.

17. System according to claim 15, characterized by a display for showing the customer equity.

18. System according to one of claims 15, characterized by a query catalog generator for autonomous and/or interactive selection of a determined query catalog in dependence on a characterizing parameter.

19. System according to one of claims 15, characterized by a data accumulation means for autonomous compilation of a selection of data to be collected in dependence on interesting queries.

20. System according to one of claims 15, characterized by a measuring head selection means for autonomous selection of the applied measuring heads in dependence on interesting queries.

21. System according to one of claims 15, characterized by a data checking means for checking the quality and/or usefulness of the at least partially automatically collected data.

22. System according to one of claims 15, characterized by at least one output means for output of queries, of information, of goods such as prepaid cards or similar gifts, und/or for provision of services such as credits and/or expressions of apology by means of voice-mail, E-mail, SMS, letter or the like, to the customers.

23. System according to claim 16, characterized by a display for showing the customer equity.

24. System according to one of claims 16, characterized by a query catalog generator for autonomous and/or interactive selection of a determined query catalog in dependence on a characterizing parameter.

25. System according to one of claims 16, characterized by a data accumulation means for autonomous compilation of a selection of data to be collected in dependence on interesting queries.

26. System according to one of claims 16, characterized by a measuring head selection means for autonomous selection of the applied measuring heads in dependence on interesting queries.

27. System according to one of claims 16, characterized by a data checking means for checking the quality and/or usefulness of the at least partially automatically collected data.

28. System according to one of claims 16, characterized by at least one output means for output of queries, of information, of goods such as prepaid cards or similar gifts, und/or for provision of services such as credits and/or expressions of apology by means of voice-mail, E-mail, SMS, letter or the like, to the customers.
